(19) United States
(12) Patent Application Publication
(10) Pub. No.: US 2014/0156112 A1
(43) Pub. Date: Jun. 5, 2014

(54) HANDS-FREE POWER TAILGATE SYSTEM AND METHOD OF CONTROLLING THE SAME

(71) Applicant: HYUNDAI MOTOR COMPANY, Seoul (KR)

(72) Inventor: Young Il LEE, Hwaseong-si (KR)

(73) Assignee: HYUNDAI MOTOR COMPANY, SEOUL (KR)

(21) Appl. No.: 13/852,733

(22) Filed: Mar. 28, 2013

(30) Foreign Application Priority Data
Dec. 4, 2012 (KR) 10-2012-0139617

(51) Int. Cl. G08C 17/02

(52) U.S. Cl. CPC G08C 17/02
USPC 701/2

(57) ABSTRACT

A hands-free power tailgate system includes an antenna, a sensor, a first unit, a second unit, and a third unit. The antenna is configured to transfer a signal for authentication for a user to a smart key and receive an authentication code from the smart key. The sensor senses a movement in rear of the vehicle. The first unit receives the authentication code from the antenna to authenticate the user and outputs a sensor activation signal and authentication information when the authentication for the user is completed. The second unit activates the sensor according to the sensor activation signal, senses a movement of the user, and outputs movement information of the user. The third unit opens a tailgate using the authentication information from the first unit and the movement information from the second unit when the user moves according to a preset moving pattern.

### CROSS-REFERENCES TO RELATED APPLICATIONS

This application is based on and claims benefit of priority of Korean patent application No. 10-2012-0139617, filed on Dec. 4, 2012, in the Korean Intellectual Property Office, the entire contents of which are hereby incorporated by reference.

### TECHNICAL FIELD

The present inventive concept relates to a hands-free power tailgate system which automatically opens and closes a tailgate (trunk) of a vehicle. More particularly, the present inventive concept relates to a hands-free power tailgate system which senses a user's moving pattern to open a tailgate.

### BACKGROUND

Recently, with high-quality of vehicles, many convenient apparatuses which provide user convenience are equipped in vehicles. One of such convenient apparatuses is a power tailgate system which automatically opens and closes a tailgate of a vehicle.

Generally, the power tailgate system for a vehicle causes the tailgate to be automatically opened and closed using many kinds of software and remote keyless entry (RKE) and also causes the tailgate to be automatically locked and released. Recently, there has been attention drawn to a hands-free power tailgate system, which causes the tailgate to be opened even when the user is carrying packages in both hands.

The conventional hands-free power tailgate system is realized by additionally mounting a separate capacitive sensor and a sensor-dedicated electronic control unit (ECU), which is configured to control the capacitive sensor, to recognize whether the user wants to open the tailgate.

However, the conventional hands-free power tailgate system has disadvantages of high configuration cost and degradation of sensing performance. Further, the system has a kick sensor type and thus the user lifts his one foot and has to cause the foot to access to a sensor at a bottom end inside a rear bumper while the user is carrying packages in both hands. Therefore, fall accidents may occur when the user lifts his one foot.

In addition, since the tailgate is opened through a kick action, if a vehicle has a tailgate having a large rotation trajectory, when the tailgate is opened, the body of the user may be collided with the tailgate.

### SUMMARY

Various aspects of the present inventive concept have been made in view of the above problems, and are to reduce configuration cost by constructing a tailgate system using apparatuses previously installed in a vehicle and to safely open a tailgate by controlling opening of the tailgate using a user's moving pattern.

An aspect of the present inventive concept relates to a hands-free power tailgate system including: a smart key antenna configured to transfer a signal for authentication for a user to a smart key and receive an authentication code from the smart key; a rear sensor configured to sense a movement in rear of the vehicle; a smart key control unit configured to receive the authentication code from the smart key antenna to authenticate the user and output a sensor activation signal and authentication information when the authentication for the user is completed; a rear control unit configured to activate the rear sensor according to the sensor activation signal, sense a movement of the user, and output movement information of the user; and a tailgate control unit configured to open a tailgate using the authentication information from the smart key control unit and the movement information from the rear control unit when the user moves according to a preset moving pattern.

Another aspect of the present inventive concept encompasses a method of controlling a hands-free power tailgate system. The method may include: performing authentication for a user using a smart key when the user approaches a vehicle; sensing a moving pattern of the user by activating a rear sensor when the authentication of the user is completed and checking whether or not the moving pattern matches a pre-registered pattern; and opening a tailgate when the moving pattern matches the pre-registered pattern.

According to exemplary embodiments of the present inventive concept, it is possible to reduce construction cost through construction of a tailgate system using previously installed apparatuses in a vehicle and to safely open the tailgate by controlling opening of the tailgate using a moving pattern of the user.

The systems and methods of the present inventive concept have other features and advantages which will be apparent from or are set forth in more detail in the accompanying drawings, which are incorporated herein, and the following Detailed Description, which together serve to explain certain principles of the present inventive concept.

### BRIEF DESCRIPTION OF THE DRAWINGS

The foregoing and other features of the inventive concept will be apparent from more particular description of embodiments of the inventive concept, as illustrated in the accompanying drawings in which like reference characters may refer to the same or similar parts throughout the different views. The drawings are not necessarily to scale, emphasis instead being placed upon illustrating the principles of the embodiments of the inventive concept.

FIG. 1 is a view illustrating a configuration of a hands-free power tai system according to an exemplary embodiment of the present inventive concept.

FIG. 2 is a flowchart illustrating a method of operating a hands-free power tailgate according to an exemplary embodiment of the present inventive concept using the hands-free power tailgate system of FIG. 1.

FIG. 3 is a schematic view illustrating a method of operating a hands-free power tailgate.

### DETAILED DESCRIPTION

Examples of the present inventive concept will be described below in more detail with reference to the accompanying drawings. The examples of the present inventive concept may, however, be embodied in different forms and should not be construed as limited to the examples set forth herein. Like reference numerals may refer to like elements throughout the specification. When it is determined that detailed description of a configuration or a function in the related disclosure interrupts understandings of embodiments in description of the embodiments of the inventive concept, the detailed description will be omitted.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g., fuels derived from resources other than petroleum). As referred to herein, a hybrid vehicle is a vehicle that has two or more sources of power, for example a vehicle that is both gasoline-powered and electric-powered.

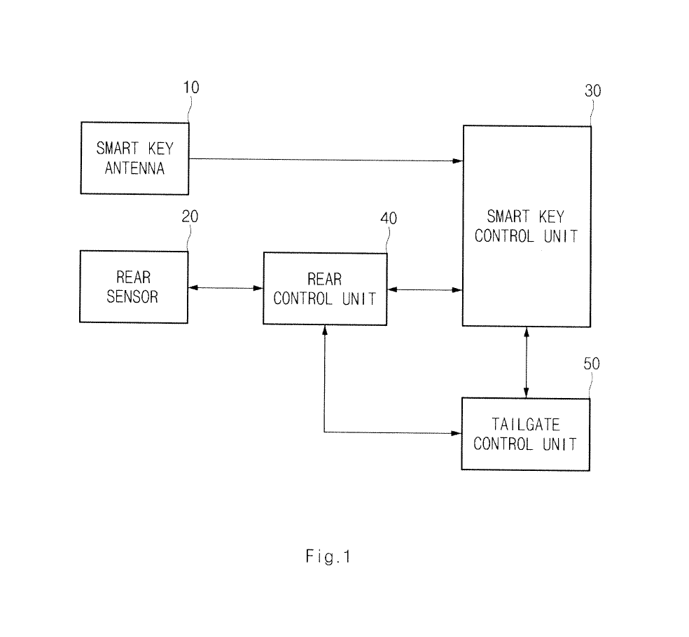

A hands-free power tailgate system of FIG. 1 may include a smart key antenna 10, a rear sensor 20, a smart key control unit 30, a rear control unit 40, and a tailgate control unit 50.

The smart key antenna 10 may transmit a low frequency (LF) signal for authentication for a user to a smart key, receives an authentication code from the smart key as a response signal to the LF signal, and transfers the authentication code to the tailgate control unit 50.

The rear sensor 20 may sense a user's movement in rear of a vehicle, and transfers a sensed signal to the rear control unit 40. The rear sensor 20 may include a rear parking assist system (RPAS) sensor which is an ultrasonic sensor installed in a rear bumper of the vehicle to assist rear parking.

The control units 30, 40 and 50 may include a processor. In some embodiments of the present inventive concept, the processor may be a general purpose microprocessor, a microcontroller, a digital signal processor, an application specific integrated circuit, a printed circuit board, a field programmable gate array, a programmable logic device, a controller, a state machine, a gated logic, discrete hardware components, an artificial neural network, combinations thereof, or any like suitable entity that can perform calculations or other manipulations of data. The processor may include a non-transitory computer-readable medium, such as a memory, which may be any physical device used to store programs or data on a temporary or permanent basis for use by the processor. The memory may be, for example, random access memory (RAM), flash memory, read only memory (ROM), programmable read only memory (PROM) electrically erasable programmable read only memory (EEPROM)), registers, hard disks, removable disks, CD-ROMS, DVDs, any combination thereof, or any other like suitable storage device or medium.

The smart key control unit 30 may authenticate the user using the authentication code provided from the smart key antenna 10 and output a sensor activation signal to the rear control unit 40 and transfer smart key authentication information to the tailgate control unit 50 when the authentication for the user is normally completed. In other words, when the authentication information is received from the smart key antenna 10, the smart key control unit 30 may compare the authentication code with pre-registered authentication information and perform the authentication for the user by checking whether or not a corresponding smart key is a registered smart key. The smart key control unit 30 may output a sensor activation signal to the rear control unit 40 and transfers the smart key authentication information to the tailgate control unit 50 when the authentication for the user is normally completed.

When the sensor activation signal is received from the smart key control unit 30, the rear control unit 40 may drive the rear sensor 20 to sense a movement (e.g., moving pattern) of the user and transfer movement information of the user (e.g., distance information between the rear sensor 20 and the user) sensed through the rear sensor 20 to the tailgate control unit 50. The rear sensor 20 and the rear control unit 40 may transmit and receive signals through local interconnect network (LIN) communication.

The tailgate control unit 50 may control an opening operation of the tailgate using the authentication information from the smart key control unit 30 and the movement information from the rear control unit 40. That is, when the authentication information is received from the smart key control unit 30, the tailgate control unit 50 may check whether or not the user moves according to a pre-registered pattern using the movement information of the user received from the rear control unit 40 and may open the tailgate when the user moves according to the pre-registered pattern. For example, the tailgate control unit 50 divides a rear zone of the vehicle into a plurality of zones (e.g., zone 1 to zone 3) according to a distance from the rear sensor 20 and checks whether the user moves through the zones according to a given condition.

At this time, the tailgate control unit 50 may output a buzzer sound when the user enters each zone to notify the user of starting of the hands-free power tailgate mode and of moving to a next zone (e.g., so as to instruct the user to move to the next zone). For example, when the user approaches a rear surface of the tailgate and enters the zone 1, the tailgate control unit 50 may output the buzzer sound to notify the user of starting of the hands-free power tailgate mode and simultaneously of moving to the zone 2 within a constant period of time (e.g., 3 seconds) so as to instruct the user to move to the zone 2 within the constant period of time. Then, when the user moves to the zone 2, the tailgate control unit 50 outputs a buzzer sound again to notify the user of normally entering the zone 2 and moving to the zone 3 within a constant period of time (e.g., 3 seconds) so as to instruct the user to move to the zone 3 within the constant period of time. Such processes may be repeatedly performed until all conditions are satisfied, and the tailgate control unit 50 may open the tailgate when all the conditions are satisfied. When the user satisfies all the moving patterns (e.g., moving patterns 1 to 3) and wants to open the tailgate, the tailgate control unit 50 may, first, output an opening alarm sound and then open the tailgate. In addition, the tailgate control unit 50 may perform the opening operation of the tailgate only when the user or a rear obstacle is spaced apart from the tailgate by a predetermined distance or more.

The smart key control unit 30, the rear control unit 40, and tailgate control unit 50 described above may transmit and receive signals using B-controller area network (B-CAN) communication.

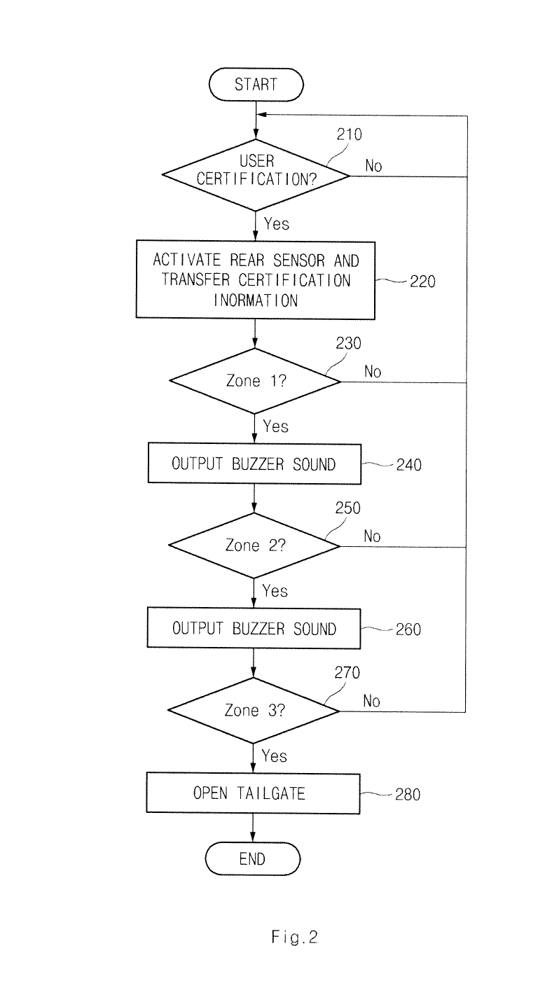

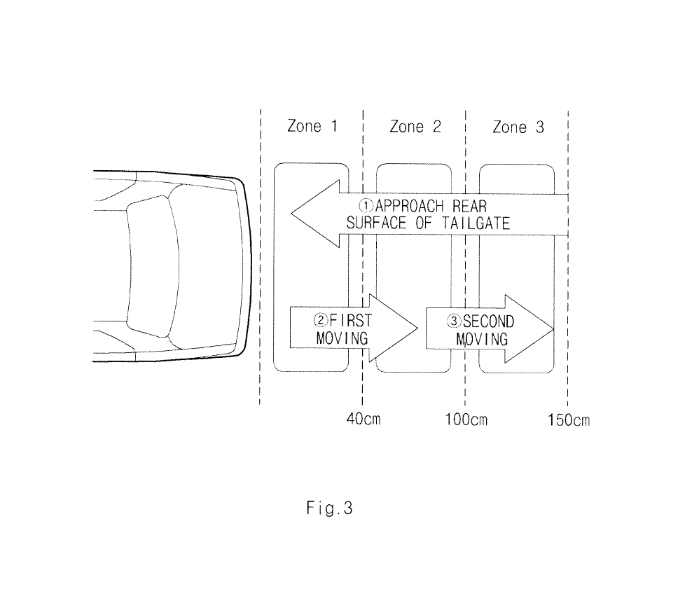

FIG. 2 is a flowchart illustrating a method of operating the hands-free power tailgate according to an exemplary embodiment of the present inventive concept using the hands-free power tailgate system of FIG. 1 and FIG. 3 is a schematic view explaining a method of operating a hands-free power tailgate.

When the user approaches the vehicle, that is, a rear surface of the tailgate, as indicated by \textcircled{1} of FIG. 3, the smart key control unit 30 may receive an authentication code from a smart key that the user possesses through the smart key antenna 10 to authenticate the user (S210 in FIG. 2).

In other words, the smart key control unit 30 may compare the authentication code of a corresponding smart key with pre-registered authentication information to check whether or not the corresponding smart key is the pre-registered smart key and thus may authenticate the user having the corresponding smart key.

When the authentication for the user is normally completed, the smart key control unit 30 may transfer the authentication information to the tailgate control unit 50 and output a sensor activation signal for activating the rear sensor 20 to the rear control unit 40 (S220).

The order of transferring the authentication information and outputting the sensor activation signal may be reversed.

The rear control unit 40 which has received the sensor activation signal may activate the rear sensor 20 and confirm whether or not the user enters a zone (e.g., zone 1) which is, for example, 40 cm or less distant from the rear sensor 20 (S230).

When the user enters the zone 1, the tailgate control unit 50 may output a buzzer sound to notify the user of starting the hands-free power tailgate mode and of moving to a zone 2 out of the zone 1 within a predetermined period of time (e.g., 3 seconds) so as to instruct the user to move to the zone 2 (see \textcircled{2} of FIG. 3) (S240 in FIG. 2).

For example, the tailgate control unit 50 may notify the user of moving (e.g., so as to instruct the user to move backwards) to a zone (e.g., the zone 2) in a range of e.g., above 40 cm to 100 cm within e.g., 3 seconds.

Next, the tailgate control unit 50 may check whether or not the user moves to the zone 2 within the predetermined period of time using movement information from the rear control unit 40 (S250 in FIG. 2).

When it is determined that the user enters the zone 2 within the predetermined period of time, the tailgate control unit 50 may output a buzzer sound again to notify the user of moving to a zone 3 out of the zone 2 within the predetermined period of time (e.g., 3 seconds) (S260 in FIG. 2).

For example, the tailgate control unit 50 may notify the user of moving (e.g., so as to instruct the user to move backwards) to a zone (e.g., the zone 3) exceeding, e.g., 100 cm from the rear sensor 20, within 3 seconds (see \textcircled{3} of FIG. 3).

Next, the tailgate control unit 50 may check whether or not the user moves to the zone 3 within the predetermined period of time using the movement information from the rear control unit 40 (S270 in FIG. 2).

When it is determined that the user enters the zone 3 within the predetermined period of time, the tailgate control unit 50 outputs a buzzer sound to notify the user of opening of the tailgate and opens the tailgate (S280 in FIG. 2).

Before opening the tailgate, the tailgate control unit 50 may check whether or not the location of the user is maintained to be 100 cm or more distant from the rear sensor 20 and open the tailgate only when the distance is maintained. When the user approaches the tailgate immediately after the buzzer sound is output such that the user is within 100 cm from the tailgate before the tailgate is opened, the tailgate control unit 50 may output an alarm sound and may not open the tailgate.

The foregoing descriptions of specific exemplary embodiments of the present inventive concept have been presented for purposes of illustration and description. They are not intended to be exhaustive or to limit the inventive, concept to the precise forms disclosed, and obviously many modifications and variations are possible in light of the above teachings. The exemplary embodiments were chosen and described in order to explain certain principles of the inventive concept and their practical application, to thereby enable others skilled in the art to make and utilize various exemplary embodiments of the present inventive concept, as well as various alternatives and modifications thereof. It is intended that the scope of the inventive concept be defined by the Claims appended hereto and their equivalents.

What is claimed is:

1. A hands-free power tailgate system, the system comprising:
a smart key antenna configured to transfer a signal for authentication for a user to a smart key and receive an authentication code from the smart key;
a rear sensor configured to sense a movement in rear of the vehicle;
a smart key control unit configured to receive the authentication code from the smart key antenna to authenticate the user and output a sensor activation signal and authentication information when the authentication for the user is completed;
a rear control unit configured to activate the rear sensor according to the sensor activation signal, sense a movement of the user, and output movement information of the user; and
a tailgate control unit configured to open a tailgate using the authentication information from the smart key control unit and the movement information from the rear control unit when the user moves according to a preset moving pattern.

2. The system of claim 1, wherein the rear sensor includes a rear parking assist system (RPAS) sensor which is an ultrasonic sensor.

3. The system of claim 1, wherein the tailgate control unit is configured to divide a rear zone of a vehicle into a plurality of zones, determine whether or not the user moves through the plurality of zones according to a preset condition, and selectively open the tailgate.

4. The system of claim 3, wherein the tailgate control unit is configured to output a buzzer sound when the user enters any one zone of the plurality of zones.

5. The system of claim 4, wherein the tailgate control unit is configured to check whether or not the user moves to another zone out of the one zone within a preset period of time after the buzzer sound is output.

6. The system of claim 3, wherein the tailgate control unit is configured to output a buzzer sound when the user enters a first zone, output a buzzer sound again when the user moves from the first zone to a second zone within a preset period of time, output an opening buzzer sound when the user moves from the second zone to a third zone within a preset period of time, and open the tailgate.

7. The system of claim 6, wherein the tailgate control unit is configured to open the tailgate only when the user is spaced apart from the tailgate by a predetermined distance.

8. A method of controlling a hands-free power tailgate, the method comprising:
performing authentication for a user using a smart key when the user approaches a vehicle;
sensing a moving pattern of the user by activating a rear sensor when the authentication of the user is completed and checking whether or not the moving pattern matches a pre-registered pattern; and
opening a tailgate when the moving pattern matches the pre-registered pattern.

9. The method of claim 8, wherein the checking whether or not the moving pattern matches a pre-registered pattern includes:
checking whether or not the user enters a first zone;
outputting a buzzer sound when it is determined that the user enters the first zone and checking whether or not the user moves to a second zone within a preset period of time; and
outputting a buzzer sound when it is determined that the user moves to the second zone and checking whether or not the user moves to a third zone within a preset period of time.

10. The method of claim 8, wherein the opening the tailgate includes opening a tailgate only when the user is spaced apart from the tailgate by a predetermined distance.
